(19) United States
(12) Patent Application Publication
(10) Pub. No.: US 2024/0116331 A1
(43) Pub. Date: Apr. 11, 2024

(54) COOLING SYSTEM FOR A MOTOR VEHICLE AND METHOD FOR OPERATING A COOLING SYSTEM

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 18/542,596

(22) Filed: Dec. 16, 2023

Related U.S. Application Data
(63) Continuation of application No. PCT/EP2022/061976, filed on May 4, 2022.

(30) Foreign Application Priority Data
Jun. 17, 2021 (DE) 10 2021 115 743.9

(51) Int. Cl. B60H 1/00

(52) U.S. Cl. CPC B60H 1/00885; B60H 1/00278; B60H 2001/00928; B60H 2001/00935; B60H 2001/00949; B60H 2001/00957

(57) ABSTRACT

A cooling system and method for a motor vehicle for circulating a coolant, having, on the one hand, a battery sub-circuit, which includes a first coolant pump and a battery, and having, on the other hand, a heating sub-circuit for heating a passenger compartment of the motor vehicle, which includes a second coolant pump, a heating air radiator, and a coolant heater for heating coolant flowing within the heating sub-circuit. The cooling system additionally includes a chiller sub-circuit having a chiller. The battery sub-circuit and/or the heating sub-circuit, and/or the chiller sub-circuit are optionally connectable to each other in a coolant-conducting manner with the aid of a multi-way valve of the cooling system.

This nonprovisional application is a continuation of International Application No. PCT/EP2022/061976, which was filed on May 4, 2022, and which claims priority to German Patent Application No. 10 2021 115 743.9, which was filed in Germany on Jun. 17, 2021, and which are both herein incorporated by reference.

### BACKGROUND OF THE INVENTION

### Field of the Invention

The present invention relates to a cooling system for a motor vehicle of and a method for operating a cooling system.

### Description of the Background Art

Cooling systems and methods for the operation thereof are already known from the conventional art in numerous design variants. The known cooling systems for motor vehicles comprise, on the one hand, a battery sub-circuit, which includes a first coolant pump and a battery and, on the other hand, a heating sub-circuit for heating a passenger compartment of the motor vehicle, which includes a second coolant pump, a heating air radiator, and a coolant heater for heating the coolant flowing within the heating sub-circuit.

### SUMMARY OF THE INVENTION

It is therefore an object of the present invention to improve a cooling system for a motor vehicle and a method for operating a cooling system.

This object is achieved in an example by a cooling system for a motor vehicle, which is characterized in that the cooling system additionally includes a chiller sub-circuit having a chiller, the battery sub-circuit and/or the heating sub-circuit and/or the chiller sub-circuit being optionally connectable to each other in a coolant-conducting manner with the aid of a multi-way valve of the coolant system. This object is furthermore achieved by a method for operating a cooling system.

An essential advantage of the invention is, in particular, that a cooling system for a motor vehicle and a method for operating a motor vehicle are improved. Due to the design according to the invention of the cooling system for a motor vehicle and the method for operating a cooling system for a motor vehicle, a highly flexible distribution of heat flows within a cooling system for a motor vehicle may be easily implemented in terms of construction, manufacturing, circuitry, and process engineering. The core functions of the cooling system according to the invention may be cost-effectively and efficiently effectuated hereby, namely the cooling of the battery with the aid of the chiller, the heating of the passenger compartment with the aid of the coolant heater and the heating air radiator, and the heating of the battery with the aid of the coolant heater.

In principle, the cooling system according to the invention for a motor vehicle is freely selectable within broad, suitable limits in terms of its type, functionality, material, and dimensioning. In particular, the cooling system according to the invention and the method according to the invention may be advantageously used in motor vehicles designed as electric vehicles. Electric vehicles in this case are generally understood to be all motor vehicles, in which the drive of the motor vehicle takes place at least partially with the aid of a battery-operated electric motor. Accordingly, motor vehicles which include so-called hybrid drives are also to be understood as electric vehicles in the aforementioned sense.

A particularly advantageous refinement of the cooling system according to the invention provides that the cooling system additionally includes a heat pump for air-conditioning the passenger compartment, the chiller simultaneously being designed as a component of the heat pump. This makes it possible to transfer heat from the surroundings and/or waste heat from the drive train sub-circuit to the vehicle interior, i.e., the passenger compartment, and to thus permit an efficient heating. A multiplicity of heat exchangers and refrigerant valves are usually necessary for this purpose. The present refinement comes into play here in that the cooling system according to the invention facilitates the aforementioned heat pump functions of the chiller and thereby reduces the costs and complexity within the refrigerant system of the heat pump, in particular by eliminating components in the heat pump.

The multi-way valve can be designed as a five-way valve, the battery sub-circuit being connected to a first and a second port of the five-way valve, the heating sub-circuit being connected to the first and a third port of the five-way valve, and the chiller sub-circuit being connected to a fourth and a fifth port of the five-way valve, in a coolant-conducting manner in each case. On the one hand, this is still a highly cost-effective variant of the cooling system according to the invention. On the other hand, it is possible with the aid of the multi-way valve designed as a five-way valve to particularly easily combine the circuitry needed for the desired operating modes into a single multi-way valve in terms of construction and manufacturing.

The first port of the five-way valve can be connected to an input of the first coolant pump, an output of the first coolant pump can be connected to an input of the battery, an output of the battery can be connected to the second port of the five-way valve, the third port of the five-way valve can be connected to an input of the second coolant pump, an output of the second coolant pump can be connected to an input of the coolant heater, an output of the coolant heater can be connected to an input of the heating air radiator, an output of the heating air radiator can be connected to the first port of the five-way valve and to the input of the first coolant pump, the fourth port of the five-way valve can be connected to an input of the chiller, and an output of the chiller can be connected to the fifth connection of the give-way valve, in a coolant-conducting manner in each case. In this way, the circuitry for implementing the aforementioned core functions of the cooling system according to the invention is very easily and thus cost-effectively effectuated.

The third port of the five-way valve and the input of the second coolant pump can be jointly connected in a coolant-conducting manner to the input of the first coolant pump, the first port of the five-way valve, and the output of the heating air radiator with the aid of a check valve, the check valve permitting a coolant flow only in the direction of the third port of the five-way valve and the input of the second coolant pump. The coolant system according to the invention is effectively protected hereby against, for example, dry running and pressure surges.

A drive train sub-circuit can be provided having a third coolant pump, power electronics, an electric motor, and a cooling air radiator for cooling the coolant flowing within the drive train sub-circuit, the drive train sub-circuit comprising a bypass line to the cooling air radiator, and the battery sub-circuit and/or the heating sub-circuit, and/or the chiller sub-circuit, and/or the drive train sub-circuit being optionally connectable to each other in a coolant-conducting manner with the aid of the aforementioned multi-way valve and a further multi-way valve of the cooling system. In this way, the efficiency of the cooling system according to the invention is significantly improved. The invention is thus available in an aforementioned cost-reduced variant as well as in a more efficient variant according to the present refinement without the underlying system having to be modified for this purpose. Only slight adaptations are necessary to convert the cost-reduced variant into the more efficient variant of the cooling system according to the invention.

The multi-way valve and the further multi-way valve can each be designed as a five-way valve, the battery sub-circuit being connected to a first port of the further five-way valve and to a second port of the five-way valve, the heating sub-circuit being connected to a first and a third port of the five-way valve and to a second port of the further five-way valve, the chiller sub-circuit being connected to a fourth port of the five-way valve and to a third port of the further five-way valve, the drive train sub-circuit being connected to a fifth port of the five-way valve and to a fourth and a fifth port of the further five-way valve in a coolant-conducting manner in each case. This makes it possible, with the aid of the two multi-way valves designed as five-way valves, to particularly easily combine the circuitry needed for the desired operating modes in terms of construction and manufacturing also for the more efficient variant of the cooling system according to the invention.

The first port of the five-way valve can be connected to the second port of the further five-way valve, the first port of the further five-way valve can be connected to an input of the first coolant pump, an output of the first coolant pump can be connected to an input of the battery, an output of the battery can be connected to the second port of the five-way valve, the third port of the five-way valve is connected to an input of the second coolant pump, an output of the second coolant pump can be connected to an input of the coolant heater, an output of the coolant heater can be connected to an input of the heating air radiator, an output of the heating radiator can be connected to the second port of the further five-way valve, the fourth port of the five-way valve can be connected to an input of the chiller, an output of the chiller is connected to the third port of the further five-way valve, the fourth port of the further five-way valve is connected to an input of the cooling air radiator, an output of the cooling air radiator is connected to an input of the third coolant pump, the fifth port of the further multi-way valve is connected to the input of the third coolant pump by means of the bypass line, an output of the third coolant pump is connected to an input of the power electronics, an output of the power electronics is connected to an input of the electric motor, an output of the electric motor is connected to the fifth port of the five-way valve, in a coolant-conducting manner in each case. In this way, the circuitry for implementing the more efficient variant of the coolant system according to the invention is effectuated very easily and thus cost-effectively.

The third port of the five-way valve and the input of the second coolant pump can be jointly connected in a coolant-conducting manner to the second port of the further five-way valve and the output of the heating air radiator with the aid of a check valve, the check valve permitting a coolant flow only in the direction of the third port of the five-way valve and the input of the second coolant pump. The cooling system according to the invention according to the more efficient variant is effectively protected hereby against dry running and pressure surfaces, similarly to the cost-reduced variant.

In principle, the method according to the invention for operating a cooling system for a motor vehicle is also freely selectable within broad, suitable limits.

Depending on the operating mode of the cooling system set with the aid of the multi-way valve and the further multi-way valve, on the one hand the battery sub-circuit can be connected to the chiller sub-circuit and, on the other hand the drive-train sub-circuit can be simultaneously connected to the heating sub-circuit in a coolant-conducting manner in each case, preferably in that the coolant flowing within the drive train sub-circuit flows through the cooling air radiator and/or in that the coolant flowing within the heating sub-circuit is partially or completely conducted to the coolant heater and the heating air radiator in a bypass with the aid of a further bypass line of the cooling system. In this way a first operating mode may be implemented, in which the battery sub-circuit and the chiller sub-circuit as well as the drive train sub-circuit and the heating sub-circuit are each connected. The first operating mode is advantageous at very high external temperatures and/or high power output of the drive train, since the battery may be cooled via the chiller independently of the ambient temperature, while the waste heat of the drive train is discharged to the surroundings via the cooling air radiator.

A second operating mode may furthermore be implemented hereby, which is advantageous at moderately cold external temperatures and average power output of the drive train, since the waste heat of the drive train may in this case be directly used to efficiently heat the vehicle interior, i.e., the passenger compartment. The multi-way valve is used to conduct only a portion of or the entire coolant flow out of the drive train sub-circuit via the heating sub-circuit, i.e. for heating purposes. If necessary, the battery may in the meantime be cooled via the chiller.

A further advantageous refinement of the method according to the invention provides that, depending on the operating mode of the cooling system set with the aid of the multi-way valve and the further multi-way valve, on the one hand the battery sub-circuit is connected to the heating sub-circuit and, on the other hand the drive-train sub-circuit is simultaneously connected to the chiller sub-circuit in a coolant-conducting manner in each case, preferably in that the coolant flowing within the drive train sub-circuit flows through the cooling air radiator, and/or in that the coolant flowing within the heating sub-circuit is partially or completely conducted to the coolant heater and the heating air radiator in a bypass with the aid of a further bypass line of the cooling system. A third operating mode may be implemented hereby, in which the battery sub-circuit and the heating sub-circuit as well as the drive train sub-circuit and the chiller sub-circuit are each connected. The third operating mode is advantageous at low external temperatures, i.e., in the case of a heat demand for the battery and/or the vehicle interior, i.e. the passenger compartment, since in this operating mode the battery and the vehicle interior may be heated via the coolant heater. The multi-way valve is used to conduct only a portion of the coolant flow from the battery sub-circuit via the heating sub-circuit, i.e., for the heating thereof.

Moreover, the drive train sub-circuit and the chiller sub-circuit can be connected by means of the present refinement for the purpose of transferring the waste heat of the drive train sub-circuit to the coolant via the chiller and subsequently to the vehicle interior, i.e., the passenger compartment. The coolant is cooled in the chiller down to a temperature which is below the ambient temperature. As a result, the coolant is reheated to the ambient temperature while flowing through the cooling radiator, i.e., the corresponding heat is removed from the ambient air. The third operating mode therefore permits not only the heating of the battery and the vehicle interior but also the use of the ambient and drive train heat in the form of a combined ambient and drive train heat pump, provided that the present refinement is used in a cooling system referring back to claim 2, i.e., in a cooling system having a heat pump.

A fourth operating mode may furthermore be implemented with the aid of the aforementioned refinement. This fourth operating mode is advantageous at very low external temperatures, i.e., in the case of a heat demand for the battery and/or the vehicle interior, i.e. the passenger compartment, since in this fourth operating mode the battery and the vehicle interior may be heated via the coolant heater. The multi-way valve is used to conduct only a portion of the coolant flow from the battery sub-circuit via the heating sub-circuit, i.e., for the heating thereof. Moreover, the drive train sub-circuit and the chiller sub-circuit are connected for the purpose of transferring the waste heat of the drive train sub-circuit to the coolant via the chiller and subsequently to the vehicle interior. In contrast to the third operating mode, the coolant is conducted by the bypass line directly back to the third coolant pump, which is connected upstream from the power electronics and the electric motor, with the aid of the further multi-way valve, bypassing the cooling air radiator. This is necessary at very low ambient temperatures, which are below the minimum possible coolant temperature due to the chiller and consequently prevents a discharge of heat from the coolant to the surroundings. Similarly to the third operating mode, the fourth operating more therefore permits not only the heating of the battery and the vehicle interior but also the use of the drive train heat in the function of a drive train heat pump, provided that the present refinement is used in a cooling system referring back to claim 2 i.e., in a cooling system having a heat pump.

Another advantageous refinement of the method according to the invention provides that, depending on the operating mode of the cooling system set with the aid of the multi-way valve and the further multi-way valve, the drive train sub-circuit and the chiller circuit, preferably the battery sub-circuit, the drive train sub-circuit, and the chiller sub-circuit, are simultaneously connected in a coolant-conducting manner, and the coolant in the heating sub-circuit is circulated in the heating sub-circuit independently of the battery sub-circuit, the drive train sub-circuit, and the chiller sub-circuit. A fifth operating mode may be implemented hereby, in which no temperature control of the battery is needed, so that the first coolant pump is switched off. The drive train generates usable waste heat for the purpose of controlling the temperature of the vehicle interior, i.e., the passenger compartment, which is transferred to the heat pump, namely to the refrigerant system of the heat pump, via the chiller. Moreover, the vehicle interior is additionally heated via the heating sub-circuit with the aid of the coolant heater if the drive train heat is insufficient.

It is furthermore possible to implement a sixth operating mode with the aid of this refinement, in which the battery is heated via the drive train waste heat, while the heating sub-circuit heats the vehicle interior, i.e., the passenger compartment, with the aid of the coolant heater, for example electrically.

A further advantageous refinement of the method according to the invention provides that, depending on the operating mode of the cooling system set with the aid of the multi-way valve and the further multi-way valve, the battery sub-circuit, the chiller sub-circuit, the drive-train sub-circuit, and the heating sub-circuit are simultaneously connected to each other in a coolant-conducting manner, preferably in that the coolant flowing in the drive train sub-circuit flows through the cooling air radiator, and/or in that the coolant flowing in the heating sub-circuit is partially or completely guided to the coolant heater and the heating air radiator in a bypass with the aid of a further bypass line of the cooling system. A seventh operating mode may be implemented in this way, in which all sub-circuits of the cooling system according to the invention are connected to each other. The drive train sub-circuit and the heating sub-circuit are first connected via the multi-way valve. The further multi-way valve then connects the heating sub-circuit to the battery sub-circuit. The multi-way valve also connects the battery sub-circuit to the chiller sub-circuit. Finally, the further multi-way valve connects the chiller sub-circuit and the drive train sub-circuit. The seventh operating mode is advantageous at cold external temperatures and a high power output of the drive train, since in this case the waste heat of the drive train may be used directly to efficiently heat the battery and the vehicle interior, i.e., the passenger compartment. The multi-way valve is used to conduct only a portion of or the entire coolant flow from the drive train sub-circuit via the heating sub-circuit, i.e. for heating purposes. The battery is subsequently heated with the aid of the residual heat in the coolant.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of the cooling system according to the invention for carrying out the method according to the invention, in a method circuit diagram;

FIG. 2 shows an example of the cooling system according to the invention for carrying out the method according to the invention, in a method circuit diagram;

FIG. 3 shows the example in a first operating mode;

FIG. 4 shows the example in a second operating mode;

FIG. 5 shows the example in a third operating mode;

FIG. 6 shows the second exemplary embodiment in a fourth operating mode;

FIG. 7 shows the example in a fifth operating mode;

FIG. 8 shows the example in a sixth operating mode; and

FIG. 9 shows the example in a seventh operating mode.

### DETAILED DESCRIPTION

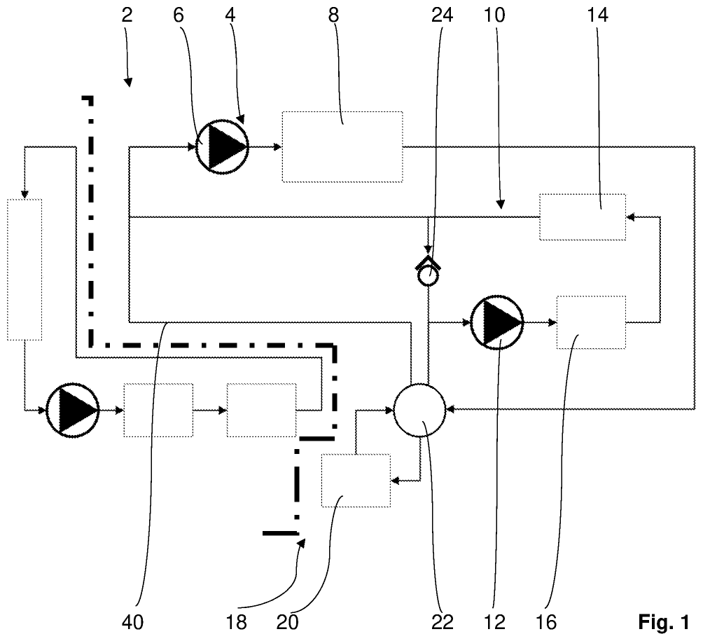

A first exemplary embodiment of the cooling system according to the invention for a motor vehicle is illustrated in FIG. 1.

The motor vehicle can be a motor vehicle designed as an electric vehicle.

Cooling system 2 for circulating a coolant and is designed as a cooling fluid, comprises, on the one hand a battery sub-circuit 4 having a first coolant pump 6 and a battery 8 and, on the other hand a heating sub-circuit 10 for heating a passenger compartment of the motor vehicle, including a second coolant pump 12, a heating air radiator 14, and a coolant heater 16 designed as an electrical PTC heater for heating the coolant flowing in heating sub-circuit 10.

According to the invention, cooling system 2 additionally includes a chiller sub-circuit 18 having a chiller 20, battery sub-circuit 4 and/or heating sub-circuit 10 and/or chiller sub-circuit 18 being optionally connectable to each other in a coolant-conducting manner with the aid of a multi-way valve 22 of cooling system 2.

Cooling system 2 in this case additionally includes a heat pump for the temperature control of the passenger compartment, chiller 20 being simultaneously designed as a component of the heat pump.

Multi-way valve 22 in this case is designed as a five-way valve, battery sub-circuit 4 being connected to a first and a second port of five-way valve 22, heating sub-circuit 10 being connected to the first and a third port of five-way valve 22, and chiller sub-circuit 18 being connected to a fourth and a fifth port of five-way valve 22, in a coolant-conductive manner in each case.

Specifically, the first port of five-way vale 22 is connected to an input of first coolant pump 6, an output of first coolant pump 6 is connected to an output of battery 8, an output of battery 8 is connected to second port of five-way valve 22, the third port of five-way valve 22 is connected to an input of second coolant pump 12, an output of second coolant pump 12 is connected to an input of coolant heater 16, an output of coolant heater 16 is connected to an input of heating air radiator 14, an output of heating air radiator 14 is connected to the first port of five-way valve 22 and to the input of first coolant pump 6, the fourth port of five-way valve 22 is connected to an input of chiller 20, and an output of chiller 20 is connected to the fifth port of five-way valve 22, in a coolant-conducting manner in each case.

In addition, the third port of five-way valve 22 and the input of second coolant pump 12 are jointly connected in a coolant-conducting manner to the input of first coolant pump 6, the first port of five-way valve 22, and the output of heating air radiator 14 via a check valve 24, check valve 24 permitting a coolant flow only in the direction of the third port of five-way valve 22 and the input of second coolant pump 12.

The first exemplary embodiment in this case corresponds to the cost-reduced variant according to the introductory part of the description, so that reference is made here to the related designs in the introductory part of the description.

A drive train of the motor vehicle, including power electronics, an electric motor, and a cooling system having a third coolant pump, the power electronics, the electric motor, and a cooling air radiator for cooling this drive train, is not operatively connected to cooling system 2 according to the first exemplary embodiment. This is clarified in FIG. 1 by a wide dot-dashed partition line, the cooling system for the aforementioned drive train being indicated to the left of the dot-dashed partition line in the image plane of FIG. 1, while cooling system 2 according to the first exemplary embodiment is illustrated to the right of the dot-dashed partition line in the image plane of FIG. 1.

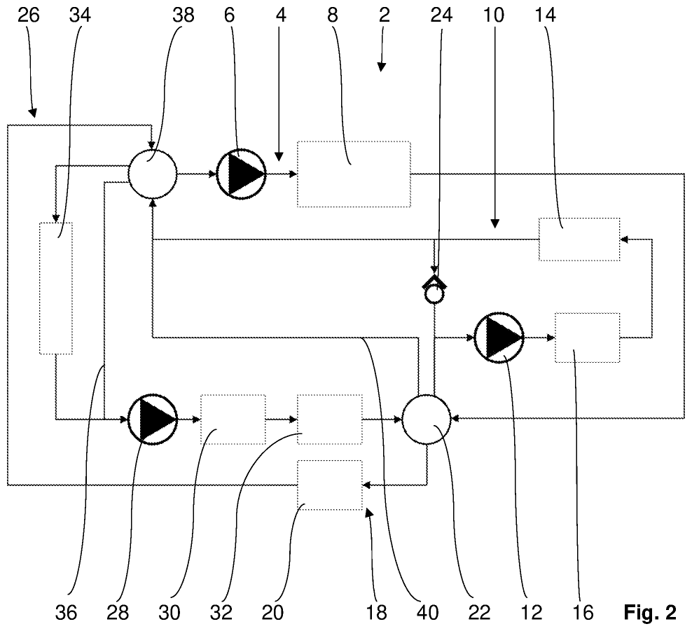

A second exemplary embodiment of the cooling system according to the invention for carrying out the method according to the invention is illustrated in FIGS. 2 through 9. The same components or components having the same functions are identified by the same reference numerals as in the first exemplary embodiment.

In contrast to the first exemplary embodiment, cooling system 2 in this case additionally includes a drive train sub-circuit 26, which has a third coolant pump 28, power electronics 30, an electric motor 32, and a cooling air radiator 34 for cooling the coolant flowing in drive train sub-circuit 26, drive train sub-circuit 26 comprising a bypass line 36 to cooling air radiator 34, and battery sub-circuit 4 and/or heating sub-circuit 10, and/or chiller sub-circuit 18, and/or drive train sub-circuit 26 being optionally connectable to each other in a coolant-conducting manner with the aid of aforementioned multi-way valve 22 and a further multi-way valve 38 of cooling system 2.

Multi-way valve 22 and further multi-way valve 38 in this case are each designed as a five-way valve, battery sub-circuit 4 being connected to a first port of further five-way valve 38 and to a second port of five-way valve 22, heating sub-circuit 10 being connected to a first and a third port of five-way valve 22 and to a second port of further five-way valve 38, chiller sub-circuit 18 being connected to a fourth port of five-way valve 22 and to a third port of further five-way valve 38, drive train sub-circuit 26 being connected to a fifth port of five-way valve 22 and to a fourth and a fifth port of further five-way valve 38, in a coolant-conducting manner in each case.

Specifically, the first port of five-way valve 22 is connected to the second port of further five-way valve 38, the first port of further five-way valve 38 is connected to an input of first coolant pump 6, an output of first coolant pump 6 is connected to an input of battery 8, an output of battery 8 is connected to the second port of five-way valve 22, the third port of five-way valve 22 is connected to an input of second coolant pump 12, an output of second coolant pump 12 is connected to an input of coolant heater 16, an output of coolant heater 16 is connected to an input of heating air radiator 14, an output of heating air radiator 14 is connected to the second port of further five-way valve 38, the fourth port of five-way valve 22 is connected to an input of chiller 20, an output of chiller 20 is connected to the third port of further five-way valve 38, the fourth port of further five-way valve 38 is connected to an input of cooling air radiator 34, an output of cooling air radiator 34 is connected to an input of third coolant pump 28, the fifth port of further multi-way valve 38 is connected to the input of third coolant pump 28 with the aid of bypass line 36, an output of third coolant pump 28 is connected to an input of power electronics 30, an output of power electronics 30 is connected to an input of electric motor 32, an output of electric motor 32 is connected to the fifth port of five-way valve 38, in a coolant-conducting manner in each case.

In addition, the third port of five-way valve 22 and the input of second coolant pump 12 are jointly connected in a coolant-conducting manner to the second port of further five-way valve 38 and to the output of heating air radiator 14 via a check valve 24, check valve 24 permitting a coolant flow only in the direction of the third port of five-way valve 22 and the input of second coolant pump 12.

The second exemplary embodiment in this case corresponds to the more efficient variant according to the introductory part of the description, so that reference is made here to the related designs in the introductory part of the description.

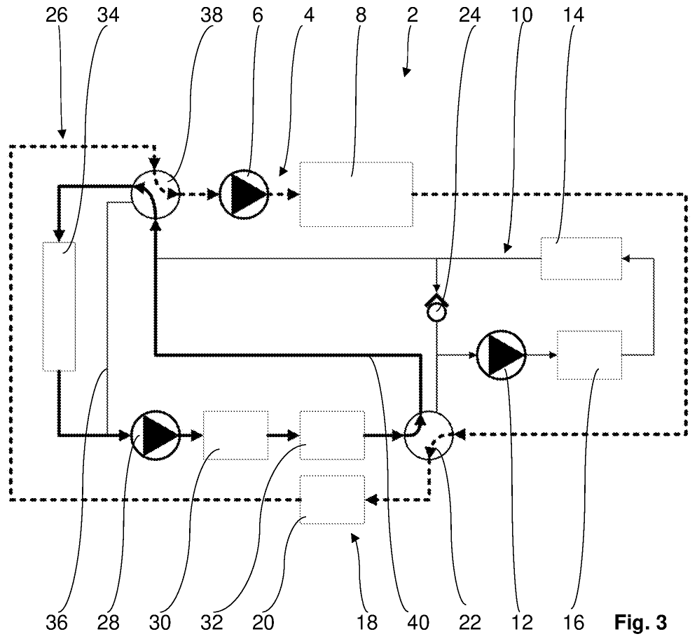

The functionality of the cooling system according to the invention and the method according to the invention according to the present first and second exemplary embodiments are explained in detail below, based on FIGS. 1 through 9. In the particular FIGS. 3 through 9, coolant flows are illustrated by solid and dashed lines having a greater dash thickness compared to the remaining lines, as well as by arrows for designating the direction of flow.

With the aid of the cost-reduced variant, i.e., the invention according to the first exemplary embodiment, it is possible to cool battery 8 with the aid of chiller 20, and/or heat the passenger compartment with the aid of coolant heater 16 and heating air radiator 14, and/or heat battery 8 with the aid of coolant heater 16, depending on an operating mode set with the aid of multi-way valve 22 from a plurality of operating modes of cooling system 2. Accordingly, the core functions of cooling system 2 may be carried out with the aid of the cost-reduced variant of the invention, i.e., the first exemplary embodiment, at a lower efficiency compared to the second exemplary embodiment.

In addition, the more efficient variant of the invention according to the second exemplary embodiment makes the following possible:

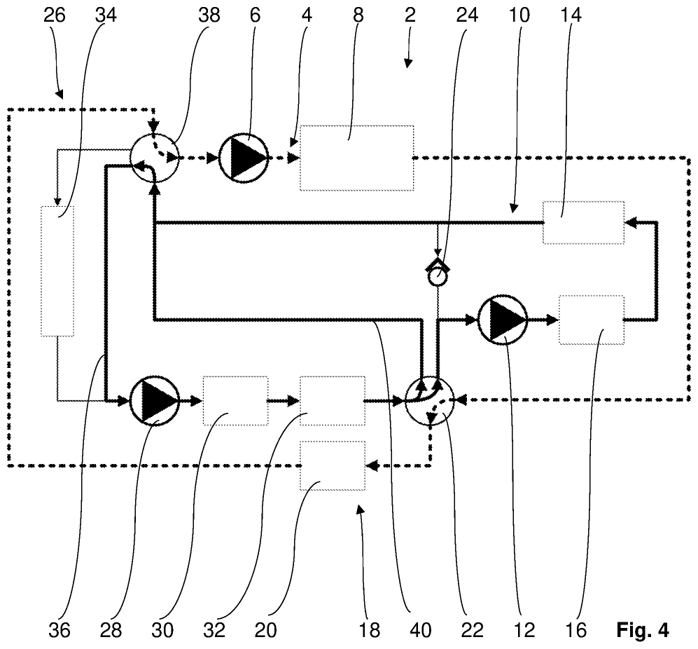

Depending on the operating mode set with the aid of multi-way valve 22 from a multiplicity of operating modes of cooling system 2, battery sub-circuit 4 is connected in a coolant-conducting manner to chiller sub-circuit 18, on the one hand, and drive train sub-circuit 26 is simultaneously connected to heating sub-circuit 10, on the other hand, in a coolant-conducting manner in each case. For example, this is done in that the coolant flowing within drive train sub-circuit 26 flows through cooling air radiator 34, and/or in that the coolant flowing within heating sub-circuit 10 is partially or completely guided to coolant heat 16 and heating air radiator 14 with the aid of a further bypass line 40 of cooling system 2. In this regard, refer to FIGS. 3 and 4, in which the first and second operating modes of cooling system 2 are illustrated according to the introductory part of the description.

It should be noted that cooling system 2 according to the first exemplary embodiment also includes a further bypass line 40. Refer to FIG. 1 in this regard.

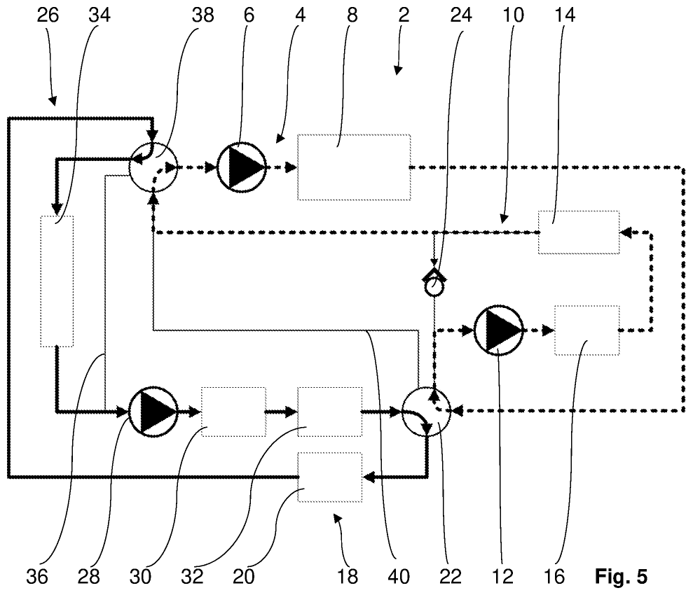

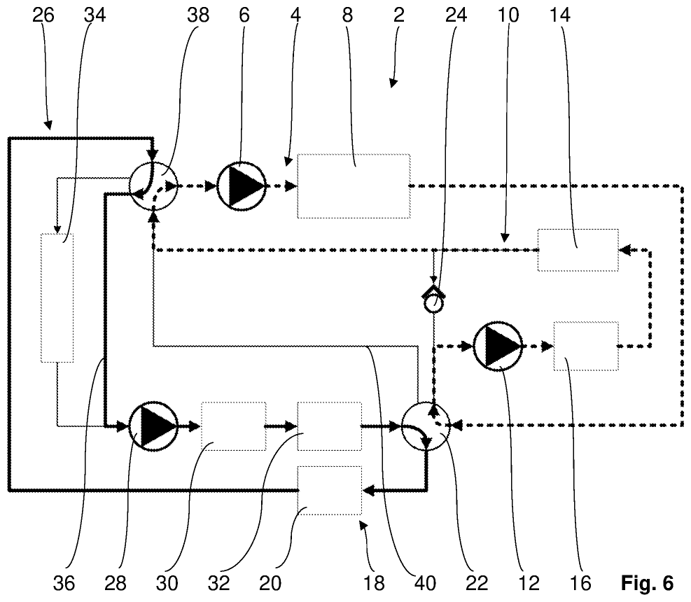

Depending on the operating mode of cooling system 2 set with the aid of multi-way valve 22 and further multi-way valve 38, battery sub-circuit 4 is connected in a coolant-conducting manner to heating sub-circuit 10, on the one hand, and drive train sub-circuit 26 is simultaneously connected to chiller sub-circuit 18, on the other hand, in a coolant-conducting manner in each case, for example in that the coolant flowing within drive train sub-circuit 26 flows through cooling air radiator 34, and/or in that the coolant flowing within heating sub-circuit 10 is partially or completely guided to coolant heater 16 and heating air radiator 14 in a bypass with the aid of further bypass line 40 of cooling system 2. In this regard, refer to FIGS. 5 and 6, in which the third and the fourth operating modes of cooling system 2 are illustrated according to the introductory part of the description.

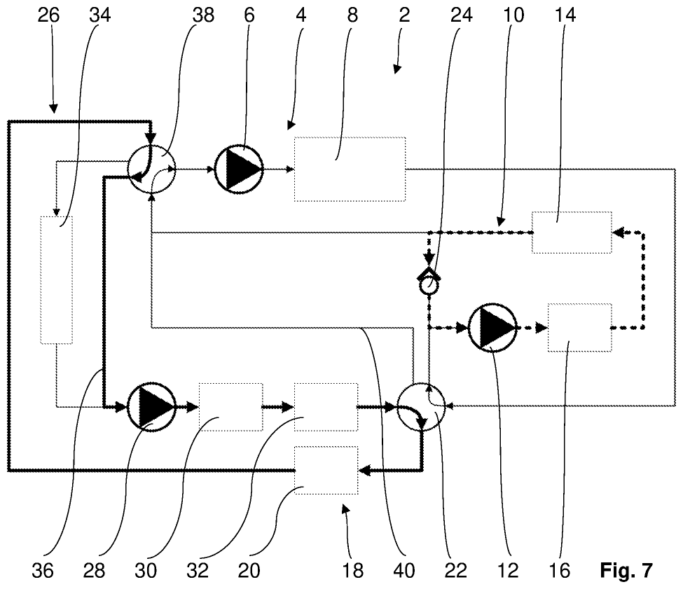

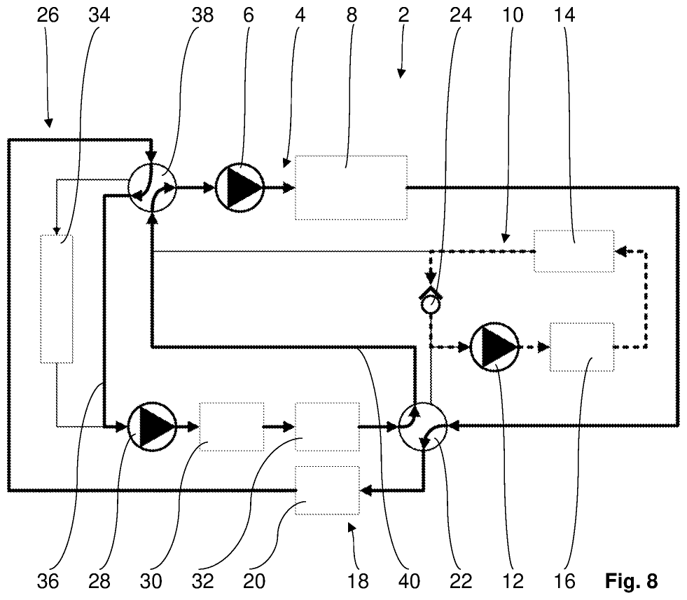

In addition, depending on the operating mode of cooling system 2 set with the aid of multi-way valve 22 and further multi-way valve 38, drive train sub-circuit 26 and chiller sub-circuit 18 or battery sub-circuit 4, drive train sub-circuit 26, and chiller sub-circuit 18 are simultaneously connected in a coolant-conducting manner, and the coolant in heating sub-circuit 10 is circulated independently of battery sub-circuit 4, drive train sub-circuit 26, and chiller sub-circuit 18. In this regard, refer to FIGS. 7 and 8, in which the fifth and the sixth operating modes of cooling system 2 are illustrated according to the introductory part of the description.

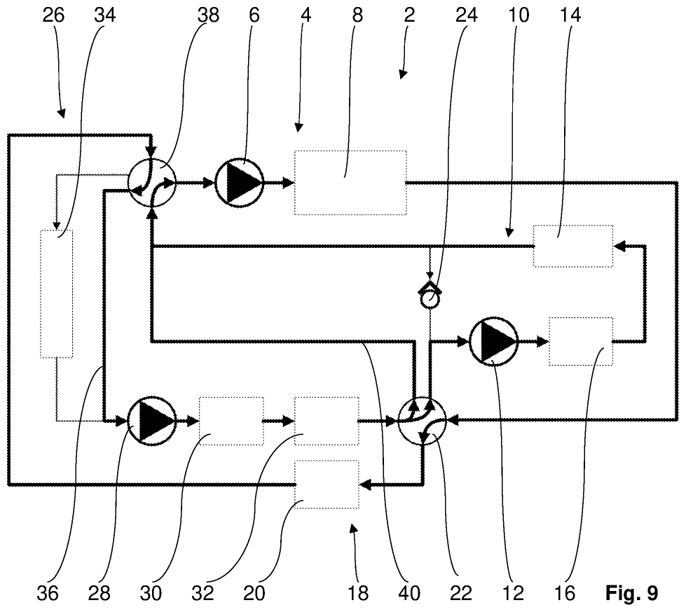

Moreover, depending on the operating mode of cooling system 2 set with the aid multi-way valve 22 and further multi-way valve 38, battery sub-circuit 4, chiller sub-circuit 18, drive train sub-circuit 26, and heating sub-circuit 10 are simultaneously connected to each other in a coolant-conducting manner, for example in such a way that the coolant flowing within drive train sub-circuit 26 flows through cooling air radiator 34, and/or in that the coolant flowing within heating sub-circuit 10 is partially or completely guided to coolant heater 16 and heating air radiator 14 in a bypass with the aid of further bypass line 40 of cooling system 2. In this regard, refer to FIG. 9, in which the seventh operating mode of cooling system 2 is illustrated according to the introductory part of the description.

With respect to the aforementioned embodiments regarding the method according to the invention according to the first and second exemplary embodiments and the specified operating modes, reference is again made here to the related designs in the introductory part of the description.

Due to the design of cooling system 2 according to the invention and the method for operating cooling system 2, a highly flexible distribution of heat flows in cooling system 2 of the motor vehicle, namely the electric vehicle, may be easily implemented in terms of construction, manufacturing, circuitry, and process engineering. The core functions of cooling system 2, namely the cooling of battery 8 with the aid of chiller 20, the heating of the passenger compartment with the aid of coolant heater 16 and heating air radiator 14, and the heating of battery 8 with the aid of coolant heater 16, may be effectuated cost-effectively and efficiently. In addition, the efficiency of cooling system 2 according to the second exemplary embodiment is significantly improved compared to the efficiency of the more cost-effective first exemplary embodiment. The invention is thus available in a cost-reduced variant as well as in a more efficient variant without the underlying system having to be modified for this purpose. Only slight adaptations are necessary to convert the cost-reduced variant into the more efficient variant of cooling system 2.

However, the invention is not limited to the present exemplary embodiments. For example, the invention may be advantageously used in other types of motor vehicles.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cooling system for a motor vehicle to circulate a coolant, the cooling system comprising:
a battery sub-circuit that includes a first coolant pump and a battery;
a heating sub-circuit to heat a passenger compartment of the motor vehicle, the heating sub-circuit comprises a second coolant pump, a heating air radiator, and a coolant heater to heat the coolant flowing in the heating sub-circuit;
a chiller sub-circuit having a chiller; and
a multi-way valve, the battery sub-circuit and/or the heating sub-circuit, and/or the chiller sub-circuit being optionally connectable to each other in a coolant-conducting manner via the multi-way valve.

2. The cooling system according to claim 1, wherein the cooling system further comprises a heat pump for air-conditioning the passenger compartment, and wherein the chiller is simultaneously configured as a component of the heat pump.

3. The cooling system according to claim 1, wherein the multi-way valve is a five-way valve, wherein the battery sub-circuit is connected to a first and a second port of the five-way valve, the heating sub-circuit is connected to the first and a third port of the five-way valve, and the chiller sub-circuit is connected to a fourth and a fifth port of the five-way valve in a coolant-conducting manner.

4. The cooling system according to claim 3, wherein the first port of the five-way valve is connected to an input of the first coolant pump, an output of the first coolant pump is connected to an input of the battery, an output of the battery is connected to the second port of the five-way valve, the third port of the five-way valve is connected to an input of the second coolant pump, an output of the second coolant pump is connected to an input of the coolant heater, an output of the coolant heater is connected to an input of the heating air radiator, an output of the heating radiator is connected to the first port of the five-way valve and to the input of the first coolant pump, the fourth port of the five-way valve is connected to an input of the chiller, and an output of the chiller is connected to the fifth port of the five-way valve in a coolant-conducting manner.

5. The cooling system according to claim 4, wherein the third port of the five-way valve and the input of the second coolant pump are jointly connected in a coolant-conducting manner to the input of the first coolant pump, the first port of five-way valve, and the output of the heating air radiator via a check valve, the check valve permitting a coolant flow only in the direction of the third port of the five-way valve and the input of the second coolant pump.

6. The cooling system according to claim 1, wherein the cooling system additionally includes a drive train sub-circuit, which has a third coolant pump, power electronics, an electric motor, and a cooling air radiator for cooling the coolant flowing within the drive train sub-circuit, the drive train sub-circuit comprising a bypass line to the cooling air radiator, and the battery sub-circuit and/or the heating sub-circuit, and/or the chiller sub-circuit, and/or the drive train sub-circuit being optionally connectable to each other in a coolant-conducting manner with the aid of the aforementioned multi-way valve and a further multi-way valve of the cooling system.

7. The cooling system according to claim 6, wherein the multi-way valve and the further multi-way valve are each designed as a five-way valve, the battery sub-circuit being connected to a first port of the further five-way valve and to a second port of the five-way valve, the heating sub-circuit being connected to a first and a third port of the five-way valve and to a second port of the further five-way valve, the chiller sub-circuit being connected to a fourth port of the five-way valve and to a third port of the further five-way valve, the drive train sub-circuit being connected to a fifth port of the five-way valve and to a fourth and a fifth port of the further five-way valve in a coolant-conducting manner.

8. The cooling system according to claim 7, wherein the first port of the five-way valve is connected to the second port of the further five-way valve, the first port of the further five-way valve is connected to an input of the first coolant pump, an output of the first coolant pump is connected to an input of the battery, an output of the battery is connected to the second port of the five-way valve, the third port of the five-way valve is connected to an input of the second coolant pump, an output of the second coolant pump is connected to an input of the coolant heater, an output of the coolant heater is connected to an input of the heating air radiator, an output of the heating air radiator is connected to the second port of the further five-way valve, the fourth port of the five-way valve is connected to an input of the chiller, an output of the chiller is connected to the third port of the further five-way valve, the fourth port of the further five-way valve is connected to an input of the cooling air radiator, an output of the cooling air radiator is connected to an input of the third coolant pump, the fifth port of the further multi-way valve is connected to the input of the third coolant pump with the aid of the bypass line, an output of the third coolant pump is connected to an input of the power electronics, an output of the power electronics is connected to an input of the electric motor, an output of the electric motor is connected to the fifth port of the five-way valve, in a coolant-conducting manner.

9. The cooling system according to claim 8, wherein the third port of the five-way valve and the input of the second coolant pump are jointly connected in a coolant-conducting manner to the second port of the further five-way valve and to the output of the heating air radiator with the aid of a check valve, the check valve permitting a coolant flow only in the direction of the third port of the five-way valve and the input of the second coolant pump.

10. A method for operating a cooling system according to claim 1, the method comprising
determining an operating mode of the cooling system; and
depending on the operating mode of the cooling system, which is set from a plurality of operating modes of the cooling system via the multi-way valve or via the multi-way valve and a further multi-way valve: the battery is cooled via the chiller, and/or the passenger compartment is heated via the coolant heater and the heating air radiator, and/or the battery is heated via the coolant heater.

11. The method according to claim 10, wherein, depending on the operating mode of the cooling system set with the aid of the multi-way valve and the further multi-way valve, the battery sub-circuit is connected in a coolant-conducting manner to the chiller sub-circuit and the drive train sub-circuit is simultaneously connected in a coolant-conducting manner to the heating sub-circuit or wherein the coolant flowing within the drive train sub-circuit flows through the cooling air radiator, and/or the coolant flowing within the heating sub-circuit is partially or completely guided to the coolant heater and the heating air radiator in a bypass with the aid of a further bypass line of the cooling system.

12. The method according to claim 10, wherein, depending on the operating mode of the cooling system set with the aid of the multi-way valve and the further multi-way valve, the battery sub-circuit is connected in a coolant-conducting manner to the heating sub-circuit and the drive train sub-circuit is simultaneously connected in a coolant-conducting manner to the chiller sub-circuit in that the coolant flowing within the drive train sub-circuit flows through the cooling air radiator and/or in that the coolant flowing within the heating sub-circuit is partially or completely guided to the coolant heater and the heating air radiator in a bypass with the aid of a further bypass line of the cooling system.

13. The method according to claim 10, wherein, depending on the operating mode of cooling system set with the aid of the multi-way valve and the further multi-way valve, the drive train sub-circuit and the chiller sub-circuit or the battery sub-circuit, the drive train sub-circuit, and the chiller sub-circuit are simultaneously connected in a coolant-conducting manner, and wherein the coolant in the heating sub-circuit is circulated independently of the battery sub-circuit, the drive train sub-circuit, and the chiller sub-circuit.

14. The method according to claim 10, wherein, depending on the operating mode of the cooling system set with the aid of the multi-way valve and the further multi-way valve, the battery sub-circuit, the chiller sub-circuit, the drive train sub-circuit, and the heating sub-circuit are simultaneously connected to each other in a coolant-conducting manner, or wherein the coolant flowing within the drive train sub-circuit flows through the cooling air radiator and/or wherein the coolant flowing within the heating sub-circuit is partially or completely guided to the coolant heater and the heating air radiator in a bypass with the aid of further bypass line of the cooling system.
